(19) United States
(12) Patent Application Publication
(10) Pub. No.: US 2014/0204194 A1
(43) Pub. Date: Jul. 24, 2014

(54) DEFECT OBSERVATION METHOD AND DEVICE THEREFOR

(71) Applicants: Yuko Otani, Tokyo (JP); Toshifumi Honda, Tokyo (JP); Yuta Urano, Tokyo (JP)

(72) Inventors: Yuko Otani, Tokyo (JP); Toshifumi Honda, Tokyo (JP); Yuta Urano, Tokyo (JP)

(73) Assignee: HITACHI HIGH TECHNOLOGIES CORPORATION, Tokyo (JP)

(21) Appl. No.: 14/116,132

(22) PCT Filed: Apr. 27, 2012
(86) PCT No.: PCT/JP2012/061316

§ 371 Date: Dec. 9, 2013

(30) Foreign Application Priority Data
May 10, 2011 (JP) 2011-104906 2011

(51) Int. Cl. G01N 21/95; G02B 26/00

(52) U.S. Cl. CPC G01N 21/9505; G02B 26/008
USPC 348/79

(57) ABSTRACT

This invention relates to a method for performing an analysis of defective material and the refractive index, and a three-dimensional analysis of very small pattern shapes including the steps of imaging by a scanning electron microscope to acquire an image of the position of a defect under observation using information of inspection results obtained by an optical inspection device, creating a model of the defect by using the acquired image of the defect under observation, calculating the values detected by the detector when reflected and scattered light emitted from a defect model is received by the detector when light is irradiated onto the defect model thus created, comparing the detection values thus calculated and the values detected by the detector, which has received light actually reflected and scattered from the sample, to obtain information relating to the height of the defect under observation, the material, or the refractive index.

### BACKGROUND

The present invention relates to a defect observation method and a device therefor in which defects and the like existing on or near the surface of a sample detected by a defect inspection device are observed.

For example, existence of foreign substances on a semiconductor substrate (wafer) and pattern defects such as short circuits or disconnections (hereinafter, these are collectively described as defects) causes failure such as insulation failure or short circuits of lines in a manufacturing process of a semiconductor device. With the advanced microfabrication of circuit patterns formed on a wafer, fine defects cause insulation failure of a capacitor and destruction of a gate oxide film or the like. These defects are mixed in various states due to various causes such as those generated from a movable part of a carrier device, generated from a human body, generated by reaction with process gas in a processing device, or mixed in chemicals or materials. Therefore, it is important in the mass production of semiconductor devices that defects generated during the manufacturing process are detected to quickly find out the cause of generation of the defects, and the generation of the defects is stopped.

As a conventional method of seeking the cause of generation of defects, there is a method in which the position of defects is first located by a defect inspection device, and the defects are observed and classified in detail by a review device such as an SEM (Scanning Electron Microscope) to be compared with a database in which inspection results obtained in each manufacturing process are stored, so that the cause of generation of the defects is estimated.

In this case, the defect inspection device is an optical defect inspection device that illuminates light on the surface of a semiconductor substrate with a laser and carries out a dark-field observation of scattered light from defects to locate the position of the defects, or an optical appearance inspection device or an SEM inspection device that irradiates light of a lamp or laser or electron beams and detects a bright-field optical image of a semiconductor substrate to be compared with reference information, so that the position of the defects on the semiconductor substrate is located. Such observation methods are disclosed in Patent Literature 1 or Patent Literature 2.

As to a device that observes defects in detail using an SEM, Patent Literature 3 describes such a method and a device that using position information of defects on a sample detected by another inspection device, the position on the sample is detected by an optical microscope mounted in the SEM defect observation device and the position information of defects obtained by detecting with the another inspection device is amended, so that the defects are observed (reviewed) in detail by the SEM defect observation device.

As to a three-dimensional shape analysis method using an SEM, Patent Literature 4 discloses a method of detecting expansion of an image of reflected electrons generated when a sample is scanned using plural detectors.

Further, Patent Literature 5 describes that a recipe is created to classify defects detected by an optical inspection device using information of the characteristic amount of defects obtained by observing with a review device.

### PRIOR ART LITERATURE

### Patent Literature

Patent Literature 1: Japanese Patent Application Laid-Open No. 2000-352697

Patent Literature 2: Japanese Patent Application Laid-Open No. 2008-157638

Patent Literature 3: US Patent No. 6407373

Patent Literature 4: Japanese Patent Application Laid-Open No. 2006-172919

Patent Literature 5: Japanese Patent Application Laid-Open No. 2004-134758

### SUMMARY

As three-dimensional shape analysis methods using an SEM, there are methods of deriving a three-dimensional shape from vectors of reflected electrons and deriving a three-dimensional shape from the shade of an obtained electron image. However, highly-accurate height measurement is not carried out in the current situation because the deriving is technically difficult and it is difficult to secure the accuracy. Further, minute heights cannot be detected by the three-dimensional analysis using an SEM because detectors are provided on the upper side.

Further, there is an SEM in which an EDS (Energy Dispersive X-ray Spectrometer) that analyzes material using characteristic X-rays generated when a sample is scanned using an electron beam is mounted to enable an analysis of material. However, it is necessary to irradiate light on a sample using highly-accelerated voltage in order to specify the material, and thus the sample is extremely damaged. In addition, it is difficult to specify the material of minute defects because the resolution is poor.

Further, defects that cannot be detected by an SEM include foreign substances in or under a membrane, crystal defects, and the like. As a cause of the impossibility, there is a difference in the penetration depth between the illumination of an optical inspection device and the illumination of a review device. In general, the illumination of the optical inspection device is deeper in the depth of the focal point than that of the review device. In the case of an SEM that is often used in a review device, the penetration depth is a few nm to 5 nm at most although it depends on accelerating voltage. For the defects that cannot be detected by an SEM, it is difficult to determine whether information of the optical inspection device is false or the defects actually exist. Further, it is impossible to derive the shapes and depths of the defects.

In the recent LSI manufacturing, target defects become much smaller due to the advanced microfabrication of circuit patterns in response to the need of high integration. In order to consider an impact of such fine defects on a semiconductor device and a cause of generation of the fine defects, it is important to obtain information of the heights of the defects, to analyze the materials and refractive indexes of the defects, and to three-dimensionally analyze the shapes of fine patterns.

Patent Literature 1 or 2 does not describe that optically-detected defects are observed by an SEM. Further, Patent Literature 3 describes that defects detected by another inspection device are sequentially observed by an SEM, but does not describe that information such as the heights, refractive indexes, and materials of the defects that are difficult to be obtained by observation using an SEM is obtained. Further, Patent Literature 4 describes that a sample is three-dimensionally analyzed using an SEM, but does not describe that information such as the refractive indexes and materials of defects is obtained. Furthermore, Patent Literature 5 describes that a recipe is created to classify defects using an image of defects detected by an SEM, but does not describe that information such as the heights, refractive indexes, and materials of defects is obtained.

Accordingly, in order to solve the problems of the prior art, the present invention provides a method and a defect observation device carrying out the method in which the heights, refractive indexes, and materials of defects are obtained using inspection information of an inspection device and observation information obtained by a review device, so that the materials and refractive indexes of the defects are analyzed and the shapes of fine patterns are three-dimensionally analyzed. Further, the present invention provides a method and a defect observation device carrying out the method in which it is determined whether or not defects that cannot be detected by a review device are real ones, and information that can specify the heights (depths), shapes, refractive indexes, and materials of the defects is obtained if the defects exist.

In order to solve the above-described problems, the present invention provides a method of observing defects on a sample in which: an image is obtained, using information of inspection results relating to defects on a sample detected by processing detection signals from detectors that receive reflected/scattered light from the sample onto which light is irradiated, by imaging a position where observation target defects extracted from the detected defects exist with a scanning electron microscope; defect models are created with a defect creating unit by using an image of the observation target defects obtained by imaging with the scanning electron microscope; candidates of detection values of the detectors are calculated by using a detection value candidate calculator in a case where the detectors receive reflected/scattered light generated from the defect models when the light is irradiated onto the defect models of the observation target; and information related to heights, materials, or refractive indexes of the observation target defects is obtained, by using a parameter calculator, by comparing the calculated candidates of the detection values of the detectors with detection values of the detectors that actually receive reflected/scattered light from the sample onto which the light is irradiated.

Further, in order to solve the above-described problems, the present invention provides a method of observing defects on a sample in which: an image is obtained, using information of inspection results relating to defects on a sample detected by processing detection signals from detectors that receive reflected/scattered light from the sample onto which light is irradiated, by imaging a position where observation target defects extracted from the detected defects exist with a scanning electron microscope; observation target defect models of the observation target defects with a first defect model creating unit are created by using an image of the observation target defects in a first defect model creating step in a case where the image of the observation target defects is contained in the image obtained by imaging with the scanning electron microscope; the observation target defect models of the observation target defects with a second defect model are created using information of the defects detected by processing the detection signals from the detectors that receive the reflected/scattered light from the sample in a second defect model creating step in the case where no image of the observation target defects is contained in the image obtained by imaging with the scanning electron microscope; the candidates of detection values of the detectors are calculated in a case where the detectors receive reflected/scattered light generated from the defect models when the light is irradiated onto the defect models of the observation target created in the first defect model creating step or the second defect model creating step; and information relating to heights, materials, or refractive indexes of the observation target defects is obtained by comparing the calculated candidates of the detection values of the detectors with detection values of the detectors that actually receive reflected/scattered light from the sample onto which the light is irradiated.

Further, in order to solve the above-described problems, the present invention provides a defect observation device that observes defects on a sample, the device including: storing unit that receives and stores information of inspection results relating to defects on a sample detected by processing detection signals from detectors that receive reflected/scattered light from the sample onto which light is irradiated in an optical inspection device; scanning electron microscope unit that obtains an image by imaging a position where observation target defects on the sample extracted from the detected defects exist on the basis of the information of the inspection results by the optical inspection device stored in the storing unit; defect model creating unit that creates defect models of the observation target defects using an image of the observation target defects on the sample obtained by imaging with the scanning electron microscope; detection value candidate calculator that calculates candidates of detection values of the detectors in a case where the detectors receive reflected/scattered light generated from the defect models created by the defect model creating unit when the light is irradiated onto the defect models of the observation target defects created by the defect model creating unit; and parameter calculator that obtains information relating to heights, materials, or refractive indexes of the observation target defects by comparing the candidates of the detection values of the detectors calculated by the detection value candidate calculator with detection values of the detectors that receive reflected/scattered light from the sample onto which the light is irradiated by the optical inspection device.

Further, in order to solve the above-described problems, the present invention provides a defect observation device that observes defects on a sample, the device including: storing unit that receives and stores information of inspection results relating to defects on a sample detected by processing detection signals from detectors that receive reflected/scattered light from the sample onto which light is irradiated in an optical inspection device; scanning electron microscope unit that obtains an image by imaging a position where observation target defects on the sample extracted from the detected defects exist on a basis of information of inspection results by the optical inspection device stored in the storing unit; first defect model creating unit that creates defect models of the observation target defects using an image of the observation target defects in a case where the image of the observation target defects is contained as a result of checking whether or not the image of the observation target defects is contained in the image obtained by imaging with the scanning electron microscope unit; second defect model creating unit that creates defect models of the observation target defects by using information of the defects detected by processing the detection signals from the detectors that receive the reflected/scattered light from the sample in the optical inspection device in a case where no image of the observation target defects is contained as a result of checking whether or not the image of the observation target defects is contained in the image obtained by imaging with the scanning electron microscope unit; detection value candidate calculator that calculates candidates of detection values of the detectors in a case where the detectors receive reflected/scattered light generated from the defect models when the light is irradiated onto the defect models of the observation target created by the first defect model creating unit or the second defect model creating unit; and parameter calculator that obtains information relating to heights, materials, or refractive indexes of the observation target defects by comparing the candidates of the detection values of the detectors calculated by the detection value candidate calculator with detection values of the detectors that actually receive reflected/scattered light from the sample onto which the light is irradiated.

According to the present invention, in the case where defects detected by an optical defect detection device are observed in detail by a review device, the heights, refractive indexes, and materials of the defects are obtained using inspection information of the inspection device and observation information obtained by the review device, so that the materials and refractive indexes of the defects can be analyzed and the shapes of fine patterns can be three-dimensionally analyzed. Further, the classification and sizing of defects that cannot be detected by the review device can be realized.

### BRIEF DESCRIPTION OF THE DRAWINGS

FIG. 1 is a block diagram for showing a configuration example of a review device in an embodiment of the present invention.

FIG. 2 is a block diagram for showing a configuration example of an inspection device in the embodiment of the present invention.

FIG. 3 is a flow diagram for explaining a procedure example of deriving defect parameters in the embodiment of the present invention.

FIG. 4A shows a top view and a side view of a defect for showing a state in which light is irradiated onto the defect with a middle height.

FIG. 4B is a diagram for showing scattered light intensity distribution generated by the defect when light is irradiated onto the defect under the conditions of FIG. 4A.

FIG. 4C shows a top view and a side view of a defect for showing a state in which light is irradiated onto the defect with a high height, and is a diagram for showing an example of scattered light intensity distribution from the defect.

FIG. 4D is a diagram for showing scattered light intensity distribution generated by the defect when light is irradiated onto the defect under the conditions of FIG. 4C.

FIG. 4E shows a top view and a side view of a defect for showing a state in which light is irradiated onto the defect with a low height, and is a diagram for showing an example of scattered light intensity distribution from the defect.

FIG. 4F is a diagram for showing scattered light intensity distribution generated by the defect when light is irradiated onto the defect under the conditions of FIG. 4E.

FIG. 5 is a flow diagram for explaining a flow of data when deriving the heights of defects in the embodiment of the present invention.

FIG. 6 is a flow diagram for explaining a procedure example of obtaining substrate information from the inspection device to derive defect parameters in the embodiment of the present invention.

FIG. 7 is a front view of a display screen for showing an example of a GUI in the embodiment of the present invention.

FIG. 8 is a block diagram for showing a configuration example different from that of the inspection device of FIG. 2 in the embodiment of the present invention.

### DESCRIPTION OF THE PREFERRED EMBODIMENTS

Hereinafter, an embodiment of the present invention will be described in detail by appropriately using the drawings.

In general, in the case where defects generated on a substrate are observed in a semiconductor manufacturing process, the observation is performed in accordance with the following defect observation procedure. First, the entire surface of a sample is scanned by an inspection device to detect defects existing on the sample, and the coordinates where the defects exist are obtained. Next, some or all of the defects detected by the inspection device are observed in detail by a review device on the basis of the defect coordinates detected by the inspection device, so that the defects are classified and the cause of generation is analyzed.

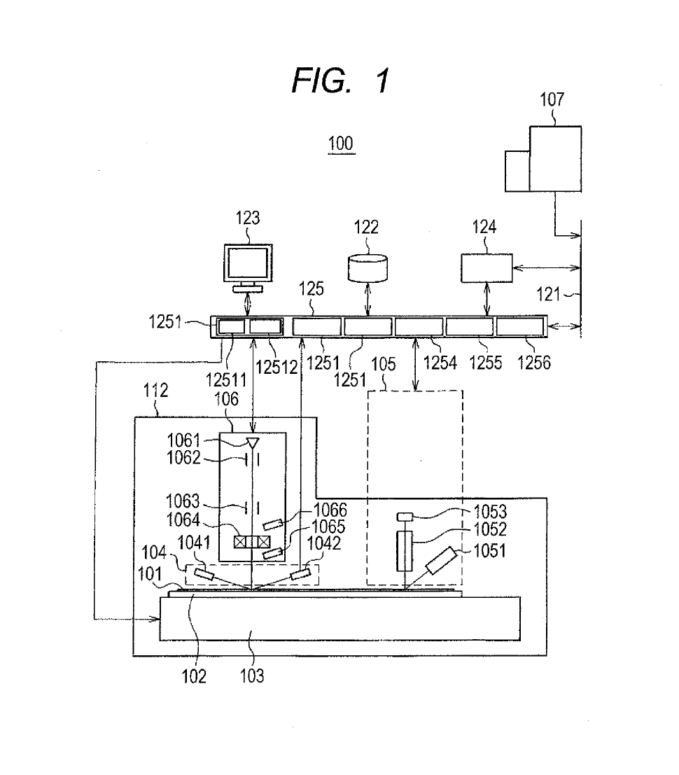

An example of a configuration of a review device 100 in the present invention is shown in FIG. 1. The review device 100 of the embodiment includes a sample holder 102 on which a sample 101 to be inspected is mounted, a stage 103 that allows the sample holder 102 to be moved so that the entire surface of the sample 101 can be moved under a scanning electron microscope 106 (hereinafter, described as SEM), the SEM 106 that observes the sample 101 in detail, an optical height detection system 104 that detects the height of the surface of the sample 101 to adjust the focal point of the SEM 106 to the surface of the sample 101, an optical microscope 105 that optically detects defects of the sample 101 to obtain detailed position information of the defects on the sample 101, a vacuum chamber 112 that holds the SEM 106 and an objective lens of the optical microscope 105, a control system 125 that controls the SEM 106, the optical height detection system 104, and the optical microscope 105, a user interface 123, a library 122, a network 121 that establishes a connection to a high-order system such as an inspection device 107, and a storage device 124 that stores external data and the like of the inspection device 107 to be supplied to the control system.

The SEM 106 includes therein an electron beam source 1061, an extraction electrode 1062 that extracts and accelerates primary electrons emitted from the electron beam source 1061 in a beam shape, a deflection electrode 1063 that controls the orbit of the primary electron beam extracted and accelerated by the extraction electrode 1062, an objective lens electrode 1064 that converges the primary electron beam with the orbit controlled by the deflection electrode 1063 onto the surface of the sample 101, a secondary electron detector 1065 that detects secondary electrons generated from the sample 101 onto which the converged primary electron beam with the orbit controlled is irradiated, and a reflected electron detector 1066 that detects relatively high-energy electrons such as reflected electrons generated from the sample 101 onto which the converged primary electron beam is irradiated.

The optical microscope 105 includes an illumination optical system 1051 that obliquely irradiates light onto the sample 101, a light collecting optical system 1052 that collects light scattered above the sample 101 among scattered light generated from the surface of the sample 101 onto which the light is irradiated from the illumination optical system 1051, and a detector 1053 that detects the scattered light from the sample 101 collected by the light collecting optical system.

The control system 125 includes a defect model creating unit 1251 having a first defect model creating unit 12511 and a second defect model creating unit 12512, a detection value candidate calculating unit 1252 that calculates candidates of detection values from a detector of the inspection device 107, parameter calculating means 1253 that obtains the height, material, or refractive index of each defect to be observed, a SEM control unit 1254 that controls the SEM 106, an optical microscope control unit 1255 that controls the optical microscope, and an entire control unit 1256 that controls the entire review device 100.

Further, the stage 103, the optical height detection system 104, the optical microscope 105, the SEM 106, the user interface 123, the library 122, and the storage device 124 are connected to the control system 125 that is connected to a high-order system (for example, the inspection device 107) via the network 121.

In the review device 100 configured as described above, in particular, the optical microscope 105 has a function of re-detecting (hereinafter, described as detecting) the defects on the sample 101 detected by the inspection device 107 using the position information of the defects detected by the inspection device 107, the optical height detection system 104 has a function as focusing means that focuses the primary electron beam to converge the primary electron beam of the SEM 106 onto the surface of the sample 101, the control system 125 has a function as position correction means that corrects the position information of the defects detected by inspecting with another inspection device on the basis of the position information of the defects detected by the optical microscope 105, and the SEM 106 has a function of observing the defects with the position information corrected by the control system 125. The stage 103 is moved between the optical microscope 105 and the SEM 106 while mounting the sample 101 thereon, so that the defects detected by the optical microscope 105 can be observed by the SEM 106.

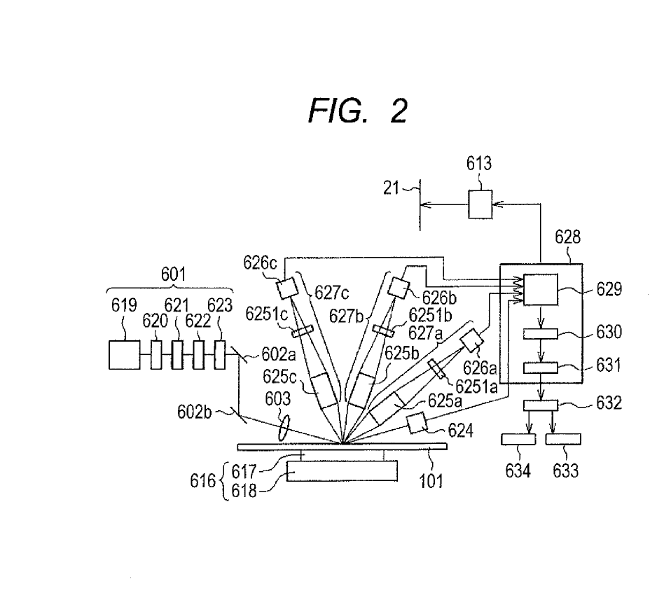

Next, an example of the inspection device 107 will be described using FIG. 2. The inspection device 107 shown in FIG. 2 includes an illumination unit 601, detecting units 627a, 627b, and 627c, a specular light detecting unit 624, a stage 616 on which the sample 101 can be mounted, a signal processing unit 628, an entire control unit 632, a display unit 633, and an input unit 634. The signal processing unit 628 has a defect determination unit 629, a characteristic amount extraction unit 630, and a defect type/dimension determination unit 631. The specular light detecting unit 624 is installed as necessary for the purpose of a large-area defect inspection or sample surface measurement. The signal processing unit 628 is connected to a storage device 613 to store results processed by the signal processing unit 628 into the storage device 613. The storage device 613 is connected to a high-order system (for example, the review device as shown in FIG. 1) via the network 121.

The illumination unit 601 is configured by appropriately using an illumination light source 619, an attenuator 620, a polarization element 621, a beam expander 622, an illuminance distribution control element 623, reflective mirrors 602a and 602b, and a light collecting lens 603. Illumination light emitted from the illumination light source 619 is adjusted to a desired beam intensity by the attenuator 620, adjusted to a desired polarization state by the polarization element 621, adjusted to a desired beam diameter by the beam expander 622, and illuminated onto an inspected area of the sample 101 through the reflective mirror 602 and the light collecting lens 603. The illuminance distribution control element 623 is used to control illumination intensity distribution on the sample 101.

FIG. 2 shows a configuration of a dark-field illumination optical system using oblique illumination in which the illumination unit 601 irradiates light from an oblique direction relative to the normal of the sample 101 and light reflected and scattered in the normal direction of the sample 101 is collected and detected. However, the invention may employ a configuration of a bright-field illumination optical system using epi-illumination in which light is irradiated from the vertical direction relative to the surface of the sample 101 and light reflected and scattered in the normal direction of the sample 101 is collected and detected. The illumination light channels may be switchable to each other through switch means.

As the illumination light source 619 to detect minute defects near the surface of the sample, used is a light source with a high output of 1 W or higher that oscillates a short-wavelength ultraviolet or vacuum ultraviolet laser beam as a wavelength that hardly penetrates into the inside of the sample. In order to detect defects inside the sample, used is a light source that oscillates a visible or infrared laser beam as a wavelength that easily penetrates into the inside of the sample. One of the light sources may be appropriately selected as a light source for oblique illumination or epi-illumination as necessary.

The stage 616 has a translation stage 618 that can be moved in an XY plane, a rotation stage 617, and a Z stage (not shown). Accordingly, the entire surface of the sample 101 within detection visual fields of the detecting units 627a, 627b, and 627c can be scanned. The detecting units 627a, 627b, and 627c are configured to collect and detect scattered light beams from the sample 101 that are generated in the azimuth directions and the elevation angles that are different from each other. The invention is not limited to the detecting units 627a, 627b, and 627c shown in FIG. 2, but plural detecting units with detection directions that are different from each other may be arranged.

The detecting unit 627a is configured by appropriately using a light collecting system 625a, a polarization filter 6251a, and a sensor 626a. An image of an illumination spot is imaged on a light receiving surface or near the same of the sensor 626a by the light collecting system 625a. A field diaphragm (not shown) having an appropriate diameter is appropriately installed at the imaging position, so that background light generated from a position other than the illumination spot can be removed and reduced.

The polarization filter 6251a can be attached to and detached from the optical axis of the light collecting system 625a, and can be rotated in the detection azimuth direction. In addition, the polarization filter 6251a is used to reduce scattered light components due to sample roughness causing noise. As the polarization filter 6251a, a wire grid polarization plate or a polarization beam splitter which has a high transmission rate and a high extinction ratios even for a short wavelength such as ultraviolet light is used. As the wire grid polarization plate, used is a structure obtained by finely processing a thin metal film such as aluminum or silver in a stripe shape.

In order to detect weak scattered light from foreign substances, a semiconductor light detector or the like coupled to a photomultiplier tube, an avalanche photodiode, or an image intensifier is appropriately used as the sensor 626a. As a photomultiplier tube to realize high sensitivity and high accuracy, it is desirable to use an ultra bialkali type or a super bialkali type with high quantum efficiency.

The configuration of the detecting unit 627a has been described above. The detecting units 627b and 627c are similarly configured.

Next, a flow of a process in which defects are detected by the inspection device 107 described using FIG. 1 and FIG. 2, and the detected defects are observed by the review device 100 described using FIG. 1 will be described using FIG. 3.

First, the sample 101 mounted on the stage 616 is scanned in the XY plane by the inspection device 107 to detect defects (S3000). Then, the inspection device 107 outputs the inspection information via the network 121, and inputs the same into the storage device 124 of the review device 100 (S6001). The inspection information of the sample 101 output from the inspection device 107 is inspection information configured using inspection results of any one or combinations of defect coordinates, defect signals, defect shapes, polarization of defect scattered light, defect types, defect labels, characteristic amounts of defects, and scattered light detection signals on the surface of the sample 101, and inspection conditions of any one or combinations of the illumination incidence angle, illumination wavelength, illumination azimuth angle, illumination intensity, and illumination polarization of the inspection device 107, the azimuth angles of the detecting units 627a, 627b, and 627c, the elevation angles of the detecting units 627a, 627b, and 627c, and detection areas of the detecting units 627a, 627b, and 627c. In the case where plural sensors exist in the inspection device, used is inspection information that is output from each sensor and obtained by inspecting the sample 101, or inspection information of the sample 101 obtained by integrating outputs from plural sensors.

Next, some or all of the defects extracted among those detected by the inspection device 107 using the information stored in the storage device 124 are observed by the review device 100 (S3002). In this case, the defects are positioned within the visual field of the review device 100 for observation on the basis of the coordinates of the defects obtained by the inspection device 107. In addition, an image of the defects is obtained and the defects are classified as necessary.

Next, a defect model is created by the defect model creating unit 1251 on the basis of the results obtained by observing the sample 101 with the review device 100 (S3003). The defect model is created on the basis of the SEM observation results obtained in S3002. For example, in the case where the SEM image of the defects can be obtained by observing with the review device 100, the defect shapes can be extracted and modeled. Further, in the case where no SEM image of the defects can be obtained, the defect model of a type that cannot be detected by the review device 100 can be created.

Next, the candidates of the detection values of the inspection device are derived from the defect model by the detection value candidate calculating unit 1252 (S3004). As a method of deriving the candidates of the detection values of the inspection device 107, there is a method in which a scattered light simulation is carried out on the basis of the defect model created in S3003 to derive the candidates of the detection values. In this case, it is necessary to carry out a simulation for unknown parameters to be obtained by creating the defect model using plural tentative values. Alternatively, there is a method of deriving the candidates of the detection values of the calculation models created in S3003 on the basis of the database created in advance before reviewing and stored in the library 122.

The data stored in the library 122 can be created on the basis of the results of preliminarily carrying out the scattered light simulation for assumed defect models, on the basis of the actual observation results, or on the basis of the both results of the scattered light simulation and the actual observation.

Further, when the candidates of the values derived from the defect model and related to the output values of the detectors of the inspection device 107 are compared with the actual output data of the inspection device (S3006), the following method can be used: the type of data used to derive unknown parameters is selected using the result of classification of the defects obtained by the inspection device 107 or the review device 100. For example, in the case where plural detectors exist in the inspection device 107, it is conceivable to evaluate using the values related to the output values of the detectors sensitive to changes of unknown parameters to be derived.

In addition, when the candidates of the detection values of the inspection device 107 are derived, the inspection results of the inspection device 107 output in S3001 or substrate conditions of the sample 101 may be used. The substrate conditions of the sample 101 can be obtained by a device different from one mounted in the inspection device 107 or the review device 100, or different from the inspection device 10 or the review device 100 used in the present invention. For example, the device can be an SEM, a transmission-type electron microscope, an electron probe microanalyzer, an Auger electron spectroscopy analyzer, an atomic force microscope, a glow discharge emission spectroscopic analyzer, an X-ray photoelectron spectrometer, an infrared spectroscopic analyzer, a laser Raman spectroscopic analyzer, a spectroscopic ellipsometer, or other spectroscopic analyzers. The device that can be mounted in the review device 100 and can measure the substrate conditions of the sample 101 can be the optical microscope 105, the optical height measuring device 104, the SEM 106, or the like. In addition, a device that is different from the inspection device 107 or the review device 100 may be preliminarily used to obtain the substrate conditions of the sample 101.

Next, the candidates of the detection values of the inspection device 107 derived from the defect model are compared with the actual data output from the inspection device 107 in the parameter calculating unit 1253 (S3005), and the unknown parameters are derived (S3006). It should be noted that in the case where the unknown parameters of defects cannot be derived in accordance with the above-described defect detection procedure, a notification of impossibility of deriving the unknown parameters is output.

Then, the defect observation results and the unknown parameters derived in S3006 are output (S3007). Next, in the case where other defect information is not necessary (NO), the observation is completed (S3009). In the case where the observation is necessary (YES), the position information of defects to be observed is obtained, and the flow returns to the procedure (S3002) of observing the defects with the review device 100 to proceed with the process.

Next, the scattered light simulation that can be used when the output candidate values of the detectors of the inspection device 107 are derived from the defect model created on the basis of the review results of the review device 100 will be described.

In the scattered light simulation, a laser beam that is illumination light 312 is irradiated onto the sample 101 from the obliquely upward direction to calculate the intensity distribution and the polarization distribution of light scattered from foreign substances or defects existing on the sample 101 at the surface (pupil surface) of an optical element of an imaging optical system nearest to the sample 101.

In addition, the number of parameters to be obtained is one or more.

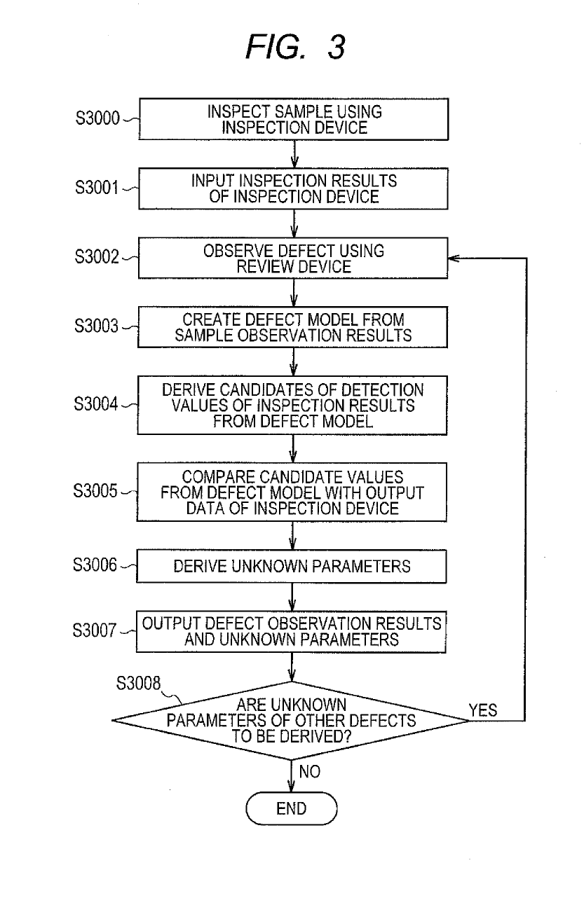

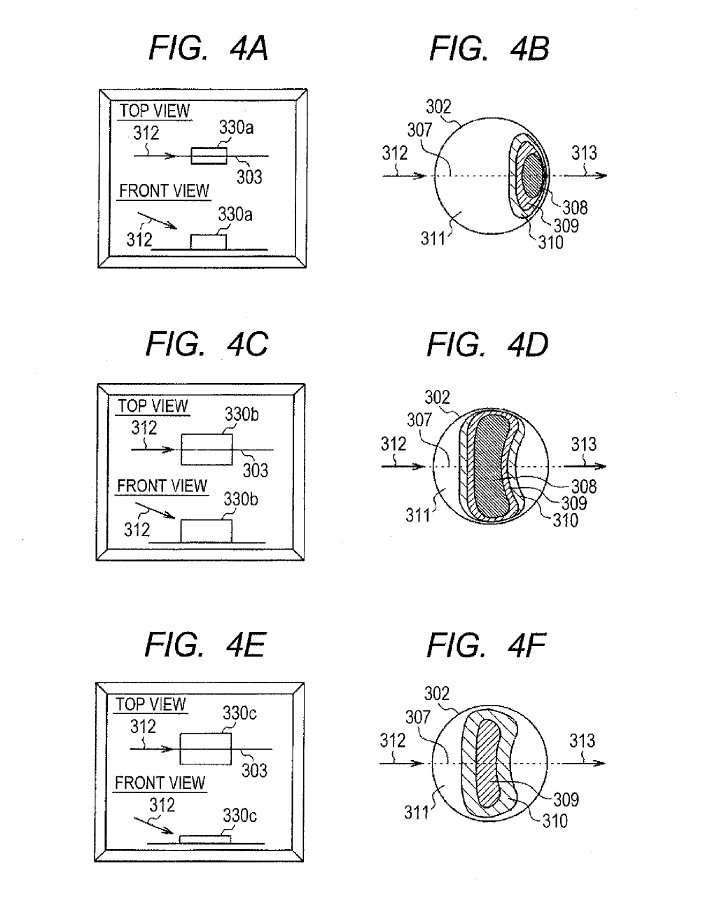

Next, an example of the scattered light intensity distribution of defects obtained by the scattered light simulation will be described using FIG. 4A to FIG. 4F.

In each of FIG. 4A, FIG. 4C, and FIG. 4E, an example of a calculation model of a defect by the scattered light simulation is shown. Illumination light beams are allowed to enter defects 330a, 330b, and 330c in the incidence directions 312 of the illumination light beams. In this case, the incidence angle of the illumination light relative to each defect stays constant. Shown is an example of the calculation models to obtain the scattered light distribution in the case where the shapes of the defects are changed to 330a in FIG. 4A, 330b in FIG. 4C, and 330c in FIG. 4E. In each drawing, Top View is a view obtained by projecting a defect model to a plane horizontal to the plane of the sample 101, and Front view is a view obtained by projecting a defect model to a plane vertical to the plane of the sample 101 and parallel to the incidence direction 312 of the illumination.

Further, an example of the scattered light intensity distribution in each shape of a defect is shown in each of FIG. 4B, FIG. 4D, and FIG. 4F. Each distribution can be obtained by the scattered light simulation. It should be noted that the scattered light intensity distribution to be obtained is not limited to those, but may be described using polarization components. The polarization components may be radial polarization or azimuth polarization, or linear polarization in which the angle of polarization is tilted in a range between n and −n, or elliptical (circular) polarization.

Each scattered light intensity distribution is a result of the scattered light simulation by the calculation model in each of FIG. 4A, FIG. 4C, and FIG. 4E.

Each of FIG. 4B, FIG. 4D, and FIG. 4F shows scattered light intensity distribution fSB (r, θ) in the case where the defect shapes are changed. In addition, an axis 307 in each scattered light intensity distribution shows an axis in the case where the incidence surface of illumination corresponds to a pupil surface 302. An arrow 312 represents the incidence direction of the illumination light, and an arrow 313 represents the specular direction of the illumination light. In each of FIG. 4B, FIG. 4D, and FIG. 4F, an area 308 represents an area with a high scattered light intensity, an area 309 represents an area with a relatively-high scattered light intensity, an area 310 represents an area with a relatively-low scattered light intensity, and an area 311 represents an area with a low scattered light intensity. These areas show relative relations between intensities in the same distribution. The same area does not necessarily represent the same intensity in each distribution (for example, the area 308 in the drawing of the scattered light intensity distribution of FIG. 4B corresponding to the defect model 330a of FIG. 4A and the area 308 in the drawing of the scattered light intensity distribution of FIG. 4D corresponding to the defect model 330b of FIG. 4C do not necessarily represent the same intensity).

As the scattered light intensity distribution shown in each of FIG. 4B, FIG. 4D, and FIG. 4F, the scattered light distribution of a defect is dependent on the defect shape. In addition, the optical characteristics of scattered light differ in scattered light intensity distribution and polarization distribution depending on the type, shape, and direction of a defect. Parameters affecting the scattered light distribution/intensity include not only the defect shapes but also the refractive indexes of the defects, the inclinations of the defects relative to the incidence direction of illumination, optical conditions such as material of the surface of the sample 101, and the structure of the surface or near the surface.

As described above, among the plural parameters affecting the scattered light distributions/intensities, a unique value is assigned to a parameter that is not to be obtained, and plural tentative values are assigned to parameters to be obtained to create plural defect models. The scattered light simulation is carried out using the plural created defect models, so that the candidate of the scattered light distribution/intensity of the target defect can be obtained.

When setting values other than the parameters to be obtained, the review results of the review device 100 and the inspection results of the inspection device 107 are used. The values that can be set using the review results of the review device 100 and are other than the parameters to be obtained include a defect shape projected on a plane parallel to the surface of the sample 101. The values that can be set using the inspection results of the inspection device 107 and are other than the parameters to be obtained include an illumination wavelength, an illumination incidence angle, an illumination intensity, illumination polarization, and the like.

The values that can be set using the review results of the review device 100 and the inspection results of the inspection device 107 include the inclinations of defects relative to illumination. This is because the scattered light intensity distribution and the polarization distribution differ due to the inclination of a defect relative to illumination light depending on the type of defect such as an anisotropic defect. Thus, it is necessary to derive the direction of illumination light in the inspection device 107 using the coordinate of the target defect obtained by the inspection device 107 or the review device 100.

However, when deriving the output candidate values of the detectors of the inspection device 107 using at least plural created defect models, it is not necessary to use the above-described scattered light simulation. In this case, there is a method in which the output values of the inspection device obtained when actually measuring the defects having the already-known shapes are used.

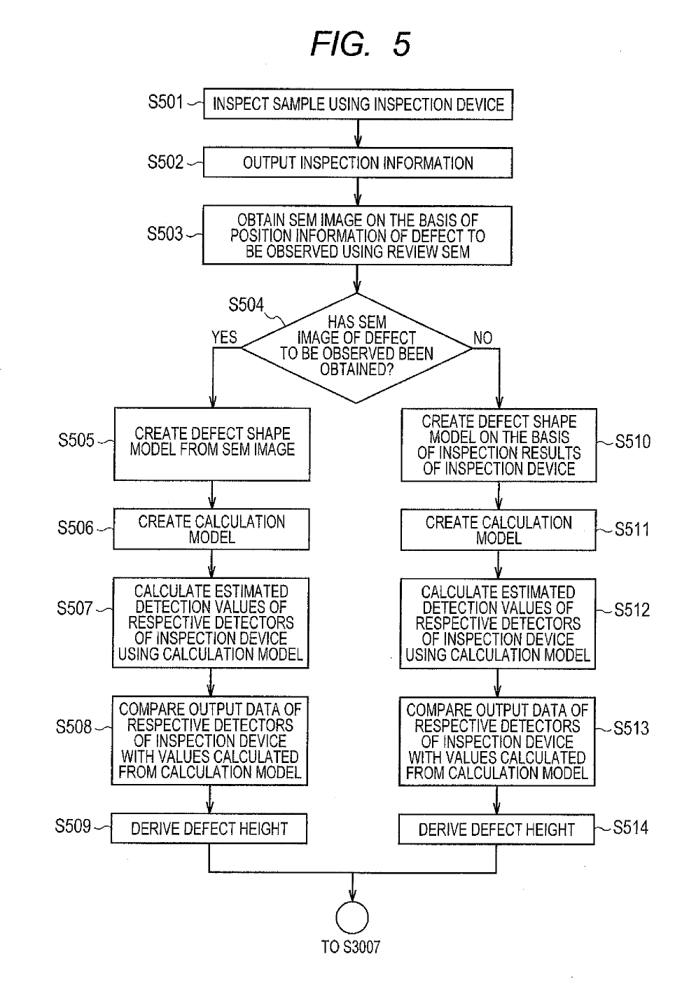

Next, an example of deriving the height of each defect as the unknown parameter of the defect in the processing flow described in FIG. 3 will be described using FIG. 5.

First, in response to S3000 of FIG. 3, the entire surface of the sample 101 is inspected by the inspection device 107 to detect defects (S501). And in response to S3001, the inspection information including the inspection results and the inspection conditions of the inspection device 107 is output (S502). The output inspection information of the inspection device 107 includes defect coordinates, values (inspection results) related to those detected using one or more detectors of the inspection device 107, and inspection conditions or inspection conditions and sample conditions.

Further, the sample conditions among the above inspection conditions or inspection conditions and the sample conditions can be obtained by a device different from one that can be mounted in the inspection device 107 or the review device 100, or that is different from the inspection device 107 or the review device 100 used in the present invention. For example, the device can be an SEM, a transmission-type electron microscope, an electron probe microanalyzer, an Auger electron spectroscopy analyzer, an atomic force microscope, a glow discharge emission spectroscopic analyzer, an X-ray photoelectron spectrometer, an infrared spectroscopic analyzer, a laser Raman spectroscopic analyzer, a spectroscopic ellipsometer, or other spectroscopic analyzers. The device that can be mounted in the review device 100 and can measure the sample conditions of the sample 101 can be the optical microscope 105, the optical height measuring device 104, the SEM 106, or the like. In addition, a device that is different from the inspection device 107 or the review device 100 may be used to obtain the sample conditions of the sample 101 in advance.

Next, the inspection information of the inspection device 107 is read by the review device 100. Then, defects are detected using the optical microscope 105 on the basis of defect coordinate data of the read inspection information of the inspection device 107, and the distance of movement of the stage is determined by amending the defect position information detected by the inspection device 107 so that the target defects to be reviewed are positioned within the visual field of the SEM 106 of the review device 100. Next, the sample 101 is moved by the distance of movement by the stage 130 to be placed at the observation position of the SEM 106, and the defects are positioned within the visual field of the SEM 106 of the review device 100.

Next, in response to S3002 of FIG. 3, the position of the target defects is observed using the review device 100 to obtain an SEM image (S503), and it is checked whether or not an image of defects is contained in the obtained SEM image (S504).

In the case where defects are contained in the obtained SEM image (YES in S504), the shape model of the defect is created using the obtained SEM image of the defects in response to S3003 of FIG. 3 (S505). For example, the shape model of the defect is a shape model obtained by projecting the defect on a plane parallel to the plane of the sample 101. In the case of foreign substances in a spherical shape, the diameter and the ellipticity are conceivable. In the case of an anisotropic defect, the width, the length, and the inclination of the defect on the SEM image are conceivable. Further, when creating the shape model obtained by projecting the defect on a plane parallel to the plane of the sample 101, the shape model can be created by processing the SEM image. For example, there is a method in which the SEM image is binarized and edges are extracted to create the defect model. In this case, some pixels of the SEM image are combined to each other to obtain an image with the lowered resolution. The calculation time can be shortened when the defect model created using an image with the lowered resolution is derived in the scattered light simulation.

Next, in response to S3004 of FIG. 3, calculation models are created using the defect models, the coordinates used in obtaining the SEM image of the defects, the results of defect classification performed using the SEM image of the defects, the inspection conditions or the inspection conditions and the sample conditions in the inspection information output from the inspection device 107 (S506). When creating the calculation models, tentative values are assigned as those of parameters to be obtained (which are heights in the case of FIG. 5) to create the calculation models. The number of tentative values is one or more, and one or more calculation models are accordingly created. For example, tentative values of 10 nm, 50 nm, 100 nm, and the like are assigned as the height parameters, so that the calculation models can be created.

Using one or more calculation models created, the candidate values (estimated detection values of the detectors 626a to 626c when the heights of the defects are used as parameters) of values related to those detected by one or more detectors of the inspection device are calculated (S507). As a method of calculating the candidate values, there is a method of carrying out the scattered light simulation described in FIG. 4 using the created calculation models. As another method of deriving the candidate values, there is a method of deriving the candidates of the detection values of the calculation models created on the basis of the database created in advance before reviewing and stored in the library 122. The data stored in the library 122 can be created on the basis of the results of carrying out the scattered light simulation for assumed calculation models in advance, on the basis of the actual observation results, or on the basis of the both results of the scattered light simulation and the actual observation. The actual observation results are inspection results of the inspection device 107 when actually measuring the defects having the already-known shapes.

Then, in response to S3005 of FIG. 3, the values related to those (outputs) detected by one or more detectors of the inspection device and the candidate values derived from the calculation models and related to those detected by one or more detectors of the inspection device are referred to and compared with each other (S508). In response to S3006 of FIG. 3, the parameters to be obtained, namely, the heights of the defects in the case of FIG. 5 are derived from the results of the reference and comparison (S509), so that the flow proceeds to the step of S3007 described in FIG. 3.

On the other hand, an SEM image of defects buried in or under an optically-transparent membrane formed on the surface of the sample 101 cannot be obtained by the review device (NO in S504).

In this case, when the target defects are detected by plural detectors such as the detectors 626a to 626c of the inspection device 107 and the detector 1053 of the optical microscope 105 mounted on the review device 100 and when it is determined that the possibility of existence of defects is infinitely high, the defect models are created on the basis of the inspection results of the inspection device in response to S3003 of FIG. 3 on the basis of information that the defects are difficult to be observed by the SEM 106 (S510). The defects that are difficult to be observed by the SEM 106 include, for example, defects in a film and crystal defects. The focal depth of an SEM generally used as a review device in a semiconductor manufacturing process is a few nm to dozen nm although the focal depth differs depending on the accelerating voltage of the SEM and the material of the sample 101. On the other hand, the focal depth of an optical microscope generally used in an inspection device is a few nm to a few pm although the focal depth differs depending on the illumination wavelength and the material of the sample 101.

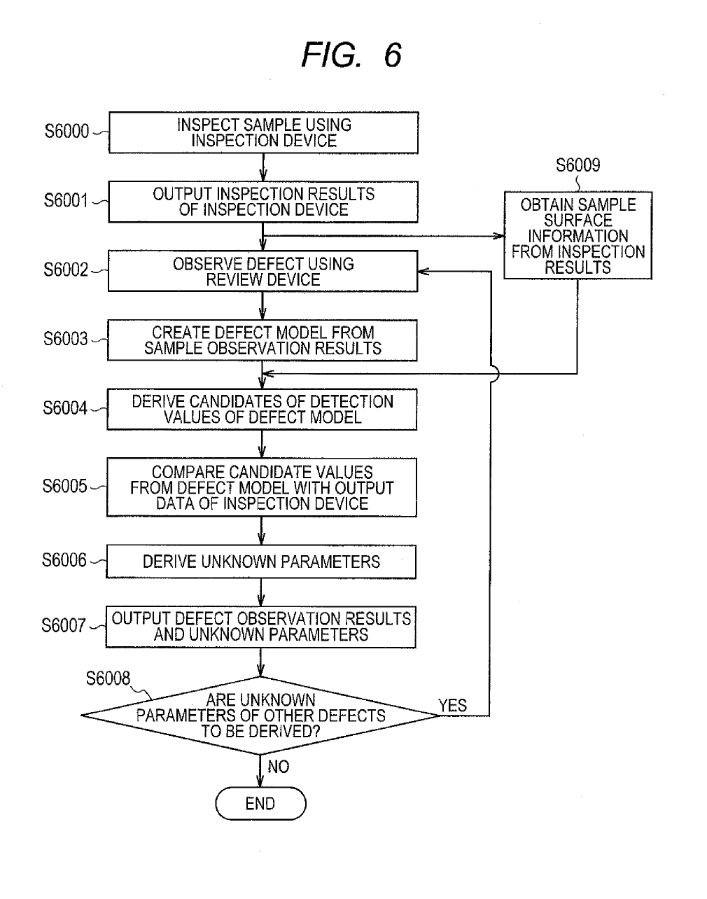

Next, using the defect models created in S510 and the inspection conditions or the inspection conditions and the sample conditions in the inspection information of the inspection device 107, the calculation models are created (S511). When creating the calculation models, tentative values are assigned as those of parameters to be obtained (which are defect shapes and the depths where the defects exist in the case of FIG. 6) to create the calculation models. The number of tentative values is one or more, and one or more calculation models are accordingly created. For example, tentative values of 1 nm, 5 nm, 10 nm, and the like are assigned as the depth parameters, so that the calculation models can be created.

Next, in response to S3004 of FIG. 3, using one or more calculation models created, the candidate values (estimated detection values of the detectors 626a to 626c corresponding to the defect shapes and depths) of values related to those detected by one or more detectors 626a to 626c of the inspection device 107 are derived (S512). As a method of deriving the candidate values, there is a method of carrying out the scattered light simulation described in FIG. 4 using the created calculation models. As another method of deriving the candidate values, there is a method of deriving the candidates of the detection values of the calculation models created on the basis of the database created in advance before reviewing and stored in the library 122. The data stored in the library 122 can be created on the basis of the results obtained by carrying out the scattered light simulation for assumed calculation models in advance, on the basis of the actual observation results, or on the basis of the both results of the scattered light simulation and the actual observation. The actual observation results are inspection results of the inspection device 107 when actually measuring the defects having the already-known shapes.

Then, in response to S3005 of FIG. 3, the values related to those detected by one or more detectors 626a to 626c of the inspection device 107 and the candidate values derived from the calculation models and related to those detected by one or more detectors of the inspection device are referred to and compared with each other (S513). In response to S3006 of FIG. 3, the parameters to be obtained, namely, the depths of the defects in the case of FIG. 5 are derived (S514), so that the flow proceeds to the step of S3007 described in FIG. 3.

When the defect shape models are created in S510, the detailed shapes of defects that cannot be detected by the review device 100 are unclear unlike those that can be detected by the review device 100. Thus, there is a possibility that the accuracy of the parameters to be derived is deteriorated. In order to secure the accuracy of the parameters to be derived, there is a method of deriving unknown parameters using not only output data of the inspection device 107, but also output data of a device mounted on the review device 100, for example, the detector 1053 of the optical microscope 105 and output data of the optical height measuring device 104. As data used for securing the accuracy, output data of a device that is different from the inspection device 107 or the review device 100 used in the present invention may be used.

In the above-described processing flow of FIG. 5, it is checked whether or not an SEM image of defects as an observation target has been obtained in S504. In the case of NO, the processes from S510 to S514 are executed. However, in the case of NO, the processes from S510 to S514 may be skipped to directly proceed to S3007.

The example described using FIG. 5 is an example in which the heights of defects are used as unknown parameters. However, the materials or the refractive indexes of defects are used as unknown parameters to perform the processes on the basis of the processes from S501 to S514, so that the materials or the refractive indexes of defects can be obtained.

Next, an example of a method of deriving the unknown parameters of defects by obtaining substrate information from the inspection device will be described using FIG. 6.

First, the sample 101 is scanned by the inspection device 107 to detect defects (S6000).

Then, the inspection device 107 outputs the inspection information containing the inspection results and the inspection conditions (S6001). The inspection data of the sample 101 output from the inspection device 107 is inspection data configured using inspection results of any one or combinations of defect coordinates, defect signals, defect shapes, polarization of defect scattered light, defect types, defect labels, characteristic amounts of defects, and scattered light detection signals on the surface of the sample 101, and inspection conditions of any one or combinations of the illumination incidence angle, illumination wavelength, illumination azimuth angle, illumination intensity, and illumination polarization of the inspection device 107, the azimuth angles of the detectors, the elevation angles of the detectors, and detection areas of the detectors. In the case where plural sensors exist in the inspection device 107, used is inspection data of the sample 101 output from each sensor, or inspection data of the sample 101 obtained by integrating outputs from plural sensors.

Next, some or all of the defects detected by the inspection device 107 are observed by the review device 100 (S6002). In this case, the defects are positioned within the visual field of the SEM 106 of the review device 100 for observation on the basis of the coordinates of the defects obtained by the inspection device 107. In addition, an image of the defects is obtained by the SEM 106 as necessary, and the defects are appropriately classified on the basis of the obtained image of the defects.

Next, a defect model is created on the basis of the results obtained by observing the sample with the review device 100 (S6003). The defect model is created on the basis of the results obtained by observing the defects with the SEM 106 of the review device 100 in S6002. For example, in the case where an image of the defects can be obtained by the SEM 106, the defect shapes can be extracted and modeled by processing the obtained SEM image. Further, in the case where no image of the defects can be obtained by the SEM 106, the defect model (for example, foreign defects in an optically-transparent film, or foreign defects or pattern defects under an optically-transparent film) of a type that cannot be detected by the SEM can be created.

On the other hand, information of the surface of the sample is obtained by processing the inspection information output from the inspection device 107 (S6009). Next, the candidates of the detection values of the detectors 626a to 626c of the inspection device 107 are derived from the defect model created in S6003 and the information of the surface of the sample 101 obtained in S6009 (S6004). As a method of deriving the candidates of the detection values of the detectors 626a to 626c of the inspection device 107, there is a method in which a scattered light simulation is carried out on the basis of the defect model created in S6003 to derive the candidates of the detection values. In this case, it is necessary to carry out the simulation by creating the defect models using plural tentative values as unknown parameters to be obtained. Alternatively, there is a method of deriving the candidates of the detection values of the calculation models created in S6003 on the basis of the database 123 created in advance the reviewing and stored in the library. The data stored in the library can be created on the basis of the results of carrying out the scattered light simulation for assumed defect models in advance, on the basis of the actual observation results, or on the basis of the both results of the scattered light simulation and the actual observation.

Further, the candidates of the values derived from the defect models and related to the output values of the detectors 626a to 626c of the inspection device 107 are compared with the actual output data of the detectors 626a to 626c of the inspection device 107 (S6005). In this case, the following method can be used: the type of data used to derive unknown parameters is selected using the result of classification of the defects obtained by the inspection device 107 or the review device 100. For example, in the case where plural detectors 626a to 626c exist in the inspection device 107, it is conceivable to evaluate using the values related to the output values of the detectors sensitive to changes of unknown parameters to be derived.

The information of the surface of the sample obtained in S6009 used when deriving the candidate values of the detection values of the inspection device 107 in S6004 is obtained from the inspection results of the inspection device 107 obtained in S6001. When deriving the information of the surface of the sample in S6009, detection values of the inspection device 107 observing a position on the sample 101 different from the defects whose unknown parameters are to be derived may be used. In the case where the information of the surface of the sample is derived, the presence or absence of defects is not considered. By using the information of the surface of the sample, the accuracy of the defect model is enhanced, and the unknown parameters can be derived with a high degree of accuracy.

Next, the candidates of the detection values of the inspection device 107 derived from the defect models created in S6003 are compared with the actual data output from the inspection device 107 (S6005), and the unknown parameters are derived (S6006). It should be noted that in the case where the unknown parameters of defects cannot be derived in accordance with the above-described defect detection procedure, a notification of impossibility of deriving the unknown parameters is output. Then, the defect observation results and the unknown parameters derived in S6006 are output (S6007).

Next, it is checked whether or not the unknown parameters of other defects are to be derived (S6008). In the case where it is not necessary to derive (NO), the observation is completed (S6010). In the case where it is necessary to observe (YES), the position information of defects to be observed is obtained, and the flow returns to the procedure (S6002) of observing the defects with the review device 100 to proceed with the processes from S6002 to S6007.

Next, the scattered light simulation that can be used when the output candidate values of the detectors 626a to 626c of the inspection device 107 are derived from the defect models created from the review results of the review device 100 will be described.

In the scattered light simulation described using FIG. 4A to 4F, a laser beam that is illumination light 312 is irradiated onto the sample 101 from the obliquely upward direction to calculate the intensity distribution and the polarization distribution of light scattered from foreign substances or defects existing on the sample 101 at the surface (pupil surface) of an optical element of an imaging optical system nearest to the sample 101.

In addition, the number of parameters to be obtained is one or more.

Next, a case in which a library and a simulation are used when the candidate values related to the output values of the detectors of the inspection device are derived from the defect models in the method of deriving unknown parameters described in FIG. 3, FIG. 5, and FIG. 6 will be described.

First, in the case where the library 122 is used to derive unknown parameters, it is apparent that the amount of information of the library 122 is extremely increased. Because it is necessary to store into the library 122 data related to the scattered light intensity from defects when changing not only parameters caused by defects such as defect types, defect shapes such as the diameters, lengths, widths and heights, the inclinations of defects, the materials of defects, and the depths in the case of defects in a film formed on the sample 101, but also various parameters such as the inspection conditions of the inspection device and the sample conditions of the sample 101. In the case where there is a problem with the capacity of the library 122, the volume of data to be stored can be reduced by decreasing the resolution of the defect model. Further, if the resolution of the defect model is low, the calculation time can be shortened even in the case where the scattered light simulation is carried out after the calculation model is created.

Next, a case in which plural detectors of the inspection device exist will be described. For example, in the case where defects are inspected by the inspection device having plural detectors as an example of the configuration of the inspection device shown in FIG. 2, it is desirable to secure as much output information of the detectors as possible. This is because if the amount of available information is large, the unknown parameters can be derived with a high degree of accuracy when deriving the unknown parameters.

For example, in the case of the inspection device in which plural detectors with different detection angles are mounted as shown in FIG. 2, the anisotropic distribution of scattered directions of the scattered light is observed depending on the shapes of defects, and the scattered light with a different intensity enters each detector. Therefore, in the case where the gain of each detector is fixed, it is conceivable that the accurate amount of scattered light becomes unclear depending on the defect shapes due to clipping of the detection values caused by the extremely-large amount of light entering the detectors, or defects cannot be detected because the amount of light entering the detectors is small.

In order to secure as many detection values of the detectors as possible, it is conceivable that defects are detected plural times in the inspection device while changing the gain of each detector.

As a method of preventing the clipping, a pre-inspection is performed using low-sensitive illumination before the surface of the sample 101 is scanned by the inspection device, and the coordinates of large defects are obtained. Then, the intensity of the illumination light is lowered near the large defects in the actual inspection or the gain of each detector is lowered, or the both are used, so that it is possible to prevent the clipping of the detectors at the large defects.

Further, there is another method of complementing the clipped detection values from unclipped ones obtained by detecting the same defects as clipped defects. The sample 101 is rotated and translated by the stage 616 on which the sample 101 is mounted, so that the sample 101 is scanned by illumination in such a mariner that areas on the sample 101 illuminated by illumination are overlapped with each other. In this case, scattered light from large defects where the detection values of the detectors are clipped is detected plural times. It is possible to complement the accurate amount of scattered light at the peak using the unclipped detection values among plural detection values obtained by detecting the scattered light from the large defects.

In the case where the defects cannot be detected because the scattered light entering the detectors from defects is weak, there is a method of increasing the gain of each detector of the inspection device, or inspecting the defects again by setting the threshold value to determine defects at a low value.

Further, using values related to the detection values of the detectors detecting the scattered light from the defects without clipping, the unknown parameters may be derived by comparison with the candidates of the detection values of the inspection device derived using the calculation model without using the detection values of the detectors that cannot detect the defects or the clipped detectors.

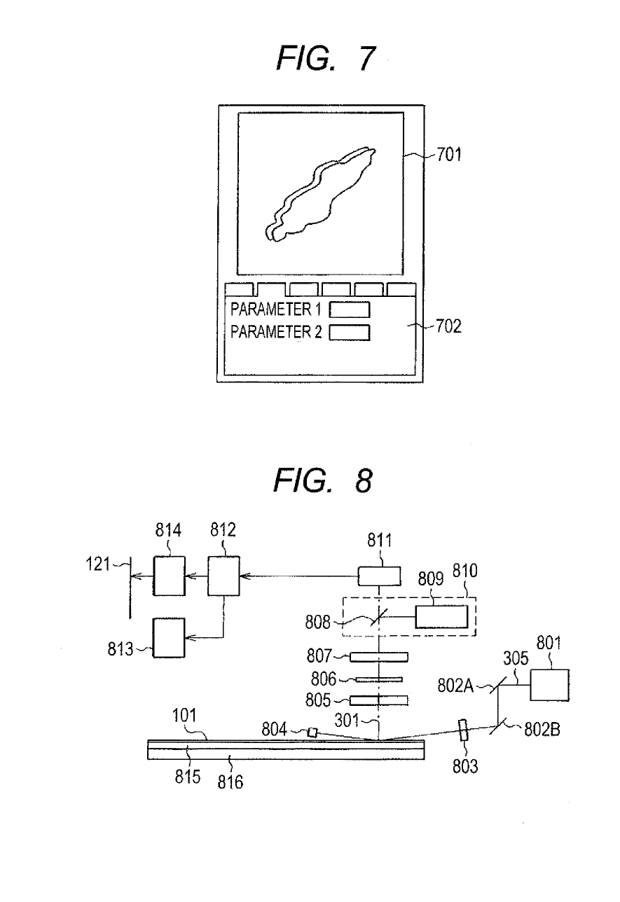

Next, an example of a GUI of a device used in the embodiment of the present invention will be described using FIG. 7. FIG. 7 shows an example in which the unknown parameters of the target defects are output in S6007 of the processing flow shown in FIG. 3 and in S6007 of the processing flow shown in FIG. 6. A defect review image 801 obtained by the review device 100 and a display section 802 that outputs the unknown parameters derived in the flow described using FIG. 3 or FIG. 6 , or the parameters used when deriving the unknown parameters and the derived unknown parameters are provided.

A configuration example of an inspection device used in the embodiment of the present invention that is different from the inspection device of FIG. 2 will be described using FIG. 8. In the example of the inspection device of FIG. 8, the inspection device that inspects the surface or defects of the sample 101 is configured by appropriately using: a dark-field illumination optical system 801 configured by appropriately using a laser, an expander, an attenuator, a polarization control element, mirrors 802A and 802B, and a lens 803; a stage 816 having a Z stage and an XY stage; a detection optical system configured by appropriately using a sample height measurement device 804, an objective lens 805, an optical filter 806, an imaging lens 807, a dichroic mirror 808 and solid imaging elements 810 and 811 on two light channels branched by the dichroic mirror 808; a signal processing unit 812; a storage device 813; and a monitor 814. The storage device 813 is connected to a high-order system (for example, the review device of the first embodiment of the present invention as shown in FIG. 1) via the network 121.

Further, the inspection device is configured by appropriately using a detection-system monitoring unit 810 that measures the state of the detection optical system configured using the dichroic mirror 808 and the solid imaging element 809, an illumination-system monitoring unit (not shown) that measures the state of the dark-field illumination optical system 801, and a control unit that controls respective operation units to be described later.

First, a configuration of the dark-field illumination system will be described. The laser irradiates illumination light 805 from the direction having an angle relative to the normal direction of the sample, and forms a desired beam in a spot or linear shape on the surface of the sample 101. The expander expands the illumination light 805 to parallel light flux with a fixed magnification. The attenuator is an attenuator to control the amount and intensity of illumination light 805 after passing through the expander. The polarization control element is an element that changes the direction of liquid crystal molecules by rotating a polarization plate or a wave plate or by turning voltage on or off to switch the polarization direction of light entering the element, and controls the polarization state. The mirrors 802A and 802B are reflecting mirrors to adjust the illumination angle when the illumination light 805 after polarization control (control of the phase and amplitude of electric field) is irradiated onto the sample 101. An example of using two mirrors is shown in this case. However, no mirrors may be used, or one mirror or three or more mirrors may be used. The lens 803 is a lens to converge the illumination light 805 at an irradiation area immediately before irradiation onto the sample 101. Further, the dark-field illumination system that can oscillate plural wavelengths may be used.

Next, a configuration of the detection optical system will be described. The objective lens 805 is an objective lens that collects light scattered and diffracted from foreign substances, defects, and patterns on the sample 101 due to irradiation of the illumination light 305 by the laser from the normal direction (upper direction) of the sample 101. In the case where the sample 101, which is inspected by the dark-field defect inspection device, is a semiconductor device having repetitive patterns, the diffracted light generated from the repetitive patterns is collected on the emitting pupil of the objective lens 805 at regular intervals. The optical filter 806 is a filter to block light of the repetitive patterns near the pupil surface, or a filter that controls and selects the polarization direction of all or some light reflected from an object to be inspected or controls and selects the polarization direction of light in the special polarization direction. A polarization distribution optical element may be used for the optical filter 806. The imaging lens 807 is a lens that allows scattered light and diffracted light from other than the repetitive patterns (for example, areas where failure occurs) and passed through the optical filter 806 to be imaged on the solid imaging element 811. The solid imaging element 811 is an optical sensor that transmits an image collected and imaged by the imaging lens 807 to the signal processing unit 812 as electron information. As a type of the optical sensor, a CCD or CMOS is generally used, but any type may be used.

The signal processing unit 812 has a circuit to convert image data received from the solid imaging element 811 to a state in which the data can be displayed on the monitor 814.

The XY stage of the stage 806 is a stage on which the sample 101 is mounted. The XY stage is moved in the plane direction to scan the sample 101, and the Z stage is a stage that moves the inspection reference plane (plane on which the sample 101 is mounted) of the XY stage in the vertical direction (Z direction). The sample height measurement unit 804 is a measurement unit to measure the heights of the inspection reference plane of the XY stage of the stage 816 and the sample 101. The focal point is automatically adjusted using the Z stage of the stage 816 and the sample height measurement unit 804, so that an autofocus function can be provided.

Next, the entire operation of the inspection device will be described. First, the illumination light 305 from the laser is illuminated on the surface of the sample 101 from the direction having an angle relative to the normal direction of the sample 101 to form a desired beam on the sample 101. Light scattered and diffracted from foreign substances, defects, and patterns on the sample 101 by the beam is collected above the sample 101 by the objective lens 805. In the case where the sample 101 has repetitive patterns, the diffracted light generated from the repetitive patterns is collected on the emitting pupil of the objective lens at regular intervals, and thus the light is blocked by the optical filter 806 mounted on the pupil plane or near the pupil plane. The optical filter 806 may emphasize the scattered light from the defects, or may be used to suppress the scattered light from the sample.

The sample 101 is mounted on the XY stage of the stage 816, and a two-dimensional image of the scattered light from the sample 101 can be obtained by scanning with the XY stage of the stage 816. In this case, the distance between the sample 101 and the objective lens 805 is measured by the sample height measurement unit 804, and is adjusted by the Z stage of the stage 816.

The two-dimensional image obtained by the solid imaging element 811 is classified according to the type of foreign substance or defect by the signal processing unit 812 to obtain the sizes of the foreign substances and defects, and the results are displayed on the monitor 814.

Further, the configuration of the inspection device is not limited to the above-described configuration, but maybe one obtained by mounting a differential interferometer in the configuration of FIG. 2 or FIG. 8.

The invention achieved by the inventors has been concretely described above on the basis of the embodiment. However, it is obvious that the present invention is not limited to the above-described embodiment, but can be variously changed without departing from the gist of the present invention.

### REFERENCE SIGNS LIST

101 . . . sample 102 . . . sample holder 103 . . . stage 104 . . . optical height detection system 105 . . . optical microscope 106 . . . electronic microscope 107 . . . inspection device 111 . . . height control mechanism 112 . . . vacuum tank 113 . . . vacuum lock window 121 . . . network 122 . . . library 123 . . . user interface 124 . . . storage device 125 . . . control system

1. A defect observation method in which defects on a sample are observed, the method comprising:
a step of obtaining an image, using information of inspection results relating to defects on a sample detected by processing detection signals from detectors that receive reflected/scattered light from the sample onto which light is irradiated, by imaging a position where observation target defects extracted from the detected defects exist with a scanning electron microscope;
a defect model creating step of creating defect models with a defect model creating unit by using an image of the observation target defects obtained by imaging with the scanning electron microscope;
a detection value candidate calculating step of calculating candidates of detection values of the detectors by using a detection value candidate calculator in a case where the detectors receive reflected/scattered light generated from the defect models when the light is irradiated onto the defect models of the observation target created in the defect model creating step, and
a parameter calculating step of obtaining information related to heights, materials, or refractive indexes of the observation target defects, by using a parameter calculator, by comparing the candidates of the detection values of the detectors calculated in the detection value candidate calculating step with detection values of the detectors that actually receive reflected/scattered light from the sample onto which the light is irradiated.

2. The defect observation method according to claim 1, wherein in the detection value candidate calculating step, plural calculation models are created using the observation target defect models created in the defect model creating step and the information of the inspection results, and the detection values of the detectors that receive reflected/scattered light from the plural calculation models when the light is irradiated onto each of the plural created calculation models are calculated.

3. The defect observation method according to claim 1, wherein in the detection value candidate calculating step, scattered light intensity distribution is obtained using the defect models of the observation target created in the defect model creating step, and the candidates of the detection values of the observation target defects are calculated using information of the obtained scattered light intensity distribution.

4. The defect observation method according to claim 1, wherein shape models of the defects are created using the image of the observation target defects in the defect model creating step, the candidates of the detection values of the detectors in the case where the detectors receive reflected/scattered light generated from shape models of the observation target defects when the light is irradiated onto the shape models of the observation target defects created in the defect model creating step are calculated in the detection value candidate calculating step, and information relating to the heights of the observation target defects is obtained in the parameter calculating step by comparing the candidates of the detection values of the detectors calculated in the detection value candidate calculating step with the detection values of the detectors that actually receive reflected/scattered light from the sample onto which the light is irradiated.

5. A method of observing defects on a sample, the method comprising:
a step of obtaining an image, using information of inspection results relating to defects on a sample detected by processing detection signals from detectors that receive reflected/scattered light from the sample onto which light is irradiated, by imaging a position where observation target defects extracted from the detected defects exist with a scanning electron microscope;
a first defect model creating step of creating defect models of the observation target defects with a first defect model creating unit by using an image of the observation target defects in a case where the image of the observation target defects is contained in the image obtained by imaging with the scanning electron microscope;
a second defect model creating step of creating defect models the observation target with a second defect model creating unit by using information of the defects detected by processing the detection signals from the detectors that receive the reflected/scattered light from the sample in a case where no image of the observation target defects is contained in the image obtained by imaging with the scanning electron microscope;
a detection value candidate calculating step of calculating candidates of detection values of the detectors in a case where the detectors receive reflected/scattered light generated from the defect models when the light is irradiated onto the defect models of the observation target created in the first defect model creating step or the second defect model creating step, and
a step of obtaining information relating to heights, materials, or refractive indexes of the observation target defects by comparing the candidates of the detection values of the detectors calculated in the detection value candidate calculating step with detection values of the detectors that actually receive reflected/scattered light from the sample onto which the light is irradiated.

6. The defect observation method according to claim 5, wherein
in the detection value candidate calculating step, calculation models are created using the observation target defect models created in the first defect model creating step or the second defect model creating step and the information of the inspection results detected by processing the detection signals from the detectors that receive the reflected/scattered light from the sample, and the detection values of the optical inspection device for the observation target defects are calculated using the created calculation models.

7. The defect observation method according to claim 5, wherein
in the detection value candidate calculating step, scattered light intensity distribution is obtained using the defect models of the observation target created in the first defect model creating step or the second defect model creating step, and the information relating to the heights, materials, or refractive indexes of the observation target defects is obtained by analyzing the observation target defects on the basis of the obtained scattered light intensity distribution.

8. A defect observation device that observes defects on a sample, the device comprising:
storing unit that receives and stores information of inspection results relating to defects on a sample detected by processing detection signals from detectors that receive reflected/scattered light from the sample onto which light is irradiated in an optical inspection device;
scanning electron microscope unit that obtains an image by imaging a position where observation target defects on the sample extracted from the detected defects exist on the basis of the information of the inspection results by the optical inspection device stored in the storing unit;
defect model creating unit that creates defect models of the observation target defects using an image of the observation target defects on the sample obtained by imaging with the scanning electron microscope;
detection value candidate calculator that calculates candidates of detection values of the detectors in a case where the detectors receive reflected/scattered light generated from the defect models created by the defect model creating unit when the light is irradiated onto the defect models of the observation target defects created by the defect model creating unit, and
parameter calculator that obtains information relating to heights, materials, or refractive indexes of the observation target defects by comparing the candidates of the detection values of the detectors calculated by the detection value candidate calculator with detection values of the detectors that receive reflected/scattered light from the sample onto which the light is irradiated by the optical inspection device.

9. The defect observation device according to claim 8, wherein the detection value candidate calculator creates plural calculation models using the observation target defect models created by the defect model creating unit and the information of the inspection results by the optical inspection device, and calculates the detection values of the detectors that receive reflected/scattered light from the plural calculation models when the light is irradiated onto each of the plural created calculation models.

10. The defect observation device according to claim 8, wherein the detection value candidate calculator obtains scattered light intensity distribution using the observation target defect models created by the defect model creating unit, and calculates the candidates of the detection values of the observation target defects using information of the obtained scattered light intensity distribution.

11. The defect observation device according to claim 8, wherein the defect model creating unit creates shape models of the defects, the detection value candidate calculator calculates the candidates of the detection values of the detectors in the case where the detectors receive reflected/scattered light generated from shape models of the defects created by the defect model creating unit, and the parameter calculator obtains information relating to the heights of the observation target defects by comparing the candidates of the detection values of the detectors calculated by the detection value candidate calculator with the detection values of the detectors.

12. A defect observation device that observes defects on a sample, the device comprising:
storing unit that receives and stores information of inspection results relating to defects on a sample detected by processing detection signals from detectors that receive reflected/scattered light from the sample onto which light is irradiated in an optical inspection device;
scanning electron microscope unit that obtains an image by imaging a position where observation target defects on the sample extracted from the detected defects exist on a basis of information of inspection results by the optical inspection device stored in the storing unit;
first defect model creating unit that creates defect models of the observation target defects using an image of the observation target defects in a case where the image of the observation target defects is contained as a result of checking whether or not the image of the observation target defects is contained in the image obtained by imaging with the scanning electron microscope unit;
second defect model creating unit that creates defect models of the observation target defects by using information of the defects detected by processing the detection signals from the detectors that receive the reflected/scattered light from the sample in the optical inspection device in a case where no image of the observation target defects is contained as a result of checking whether or not the image of the observation target defects is contained in the image obtained by imaging with the scanning electron microscope unit;
detection value candidate calculator that calculates candidates of detection values of the detectors in a case where the detectors receive reflected/scattered light generated from the defect models when the light is irradiated onto the defect models of the observation target created by the first defect model creating unit or the second defect model creating unit, and
parameter calculator that obtains information relating to heights, materials, or refractive indexes of the observation target defects by comparing the candidates of the detection values of the detectors calculated by the detection value candidate calculator with detection values of the detectors that actually receive reflected/scattered light from the sample onto which the light is irradiated.

13. The defect observation device according to claim 12, wherein the detection value candidate calculator creates calculation models using the observation target defect models created by the first defect model creating unit or the second defect model creating unit and the information of the inspection results detected by processing the detection signals from the detectors that receive the reflected/scattered light from the sample, and calculates detection values of the optical inspection device for the observation target defects using the created calculation models.

14. The defect observation device according to claim 12, wherein the detection value candidate calculator obtains scattered light intensity distribution using the observation target defect models created by the first defect model creating unit or the second defect model creating unit, and obtains the information relating to the heights, materials, or refractive indexes of the observation target defects by analyzing the observation target defects on the basis of the obtained scattered light intensity distribution.
